(19) United States
(12) Patent Application Publication
(10) Pub. No.: US 2024/0365734 A1
(43) Pub. Date: Nov. 7, 2024

(54) VERTICAL FARMING SYSTEM

(71) Applicant: CHANGYANG Technology Ltd., Taichung City (TW)

(72) Inventors: YU-TSE WU, Taichung City (TW); YAO-MING YANG, Taichung City (TW)

(73) Assignee: CHANGYANG Technology Ltd., Taichung City (TW)

(21) Appl. No.: 18/650,130

(22) Filed: Apr. 30, 2024

(30) Foreign Application Priority Data
May 4, 2023 (TW) 112116611

(51) Int. Cl. A01G 31/06; A01G 31/00

(52) U.S. Cl. CPC A01G 31/06; A01G 2031/006

(57) ABSTRACT

A vertical farming system includes a support unit, at least one planting assembly, and a water circulation assembly. The support unit includes a fixing rack provided with at least one positioning portion. The at least one planting assembly includes a hanging member and at least one plant container hung below the fixing rack through the hanging member and having a drainage hole. The hanging member has a head detachably engaged with the positioning portion. The water circulation assembly includes a nutrient device and a pipeline having at least one outlet hole and at least one collection hole. The nutrient device is disposed on the pipeline and is located between the outlet hole and the collection hole. Irrigation water passes through the outlet hole to irrigate plants and then passes through the drainage hole of the plant container and returns to the pipeline through the collection hole.

### BACKGROUND OF THE INVENTION

### Technical Field

The present invention relates generally to an agricultural system, and more particularly to a vertical farming system suitable for large-scale planting.

### Description of Related Art

In order to cope with an increase in food need due to an increase in global population, nowadays agricultural systems are generally required to produce a large number of crops for supporting the development and use of the global population.

Conventional agricultural systems are typically applied to an outdoor environment or an indoor environment. A conventional agricultural system applied to the outdoor environment is to cultivate plants in soils of a farm. A conventional agricultural system applied to the indoor environment is to perform planting in a greenhouse or an indoor environment with a system regulating environmental factors, such as temperature, humidity, sunlight, etc.

However, the conventional agricultural system applied to the outdoor environment and the conventional agricultural system applied to the indoor environment still have room for improvement. The conventional agricultural system applied to the outdoor environment typically requires a land with a large area in order to perform planting and crop production in a large scale, which increases the cost of land and is inconducive to circulating valuable water resource as excessive water is lost to the soils during irrigating the plants. The conventional agricultural system applied to the indoor environment typically places and fixes the plants in soils or containers; during harvesting crops, workers are required to move to one plant for harvesting and then move to another plant for subsequent harvesting, which is inconvenient for the workers to harvest and hence reduces the harvesting efficiency.

### BRIEF SUMMARY OF THE INVENTION

In view of the above, the primary objective of the present invention is to provide a vertical farming system which could plant a large number of plants in an environment with a limited space, thereby reducing the cost of land; irrigation water could be circulated and reused, thereby reducing the waste of water resource; the plants could be transported to different places for harvesting conveniently, thereby increasing the harvesting efficiency.

The present invention provides a vertical farming system including a support unit, at least one planting assembly, and a water circulation assembly. The support unit includes a fixing rack that is raised relative to a floor. At least one positioning portion is provided on the fixing rack. The at least one planting assembly includes a hanging member and at least one plant container. The at least one plant container is hung below the fixing rack through the hanging member. The at least one plant container has a drainage hole adapted to drain irrigation water. The hanging member has a head, wherein the head is detachably engaged with the at least one positioning portion of the fixing rack. The water circulation assembly includes a pipeline and a nutrient device. The pipeline has at least one outlet hole and at least one collection hole. The nutrient device is disposed on a water pathway of the pipeline and is located between the at least one outlet hole and the at least one collection hole. The nutrient device is adapted to regulate a composition of the irrigation water. The irrigation water passes through the at least one outlet hole to irrigate plants in the at least one plant container. When the irrigation water passes through the drainage hole of the at least one plant container, the irrigation water returns to the pipeline through the at least one collection hole.

With the aforementioned design, the irrigation water could be effectively circulated and reused through the water circulation assembly, thereby reducing the waste of water resource. The head of the hanging member is detachably engaged with the at least one positioning portion of the fixing rack, so that the at least one planting assembly could be transported to different places for harvesting conveniently, thereby enhancing the harvesting efficiency. Moreover, in comparison with a conventional agricultural system that requires a large space of growing a large number of plants, when a plurality of plant containers of the present invention is disposed, the plant containers could be stacked on one another, so that the vertical farming system of the present invention could reduce a space required to dispose the at least one planting assembly, thereby reducing the cost of land by growing a large number of plants in a limited space.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a perspective view of the vertical farming system according to an embodiment of the present invention;

FIG. 2 is a schematic view showing a part of the vertical farming system according to the embodiment of the present invention;

FIG. 3 is a partially enlarged view of FIG. 1;

FIG. 4 is a sectional view along the 4-4 line in FIG. 3;

FIG. 5 is a sectional view along the 5-5 line in FIG. 3;

FIG. 6 is a sectional schematic view, showing that the plant containers are stacked according to the embodiment of the present invention; and

FIG. 7 is a perspective view, showing another part of the vertical farming system according to the embodiment of the present invention;

### DETAILED DESCRIPTION OF THE INVENTION

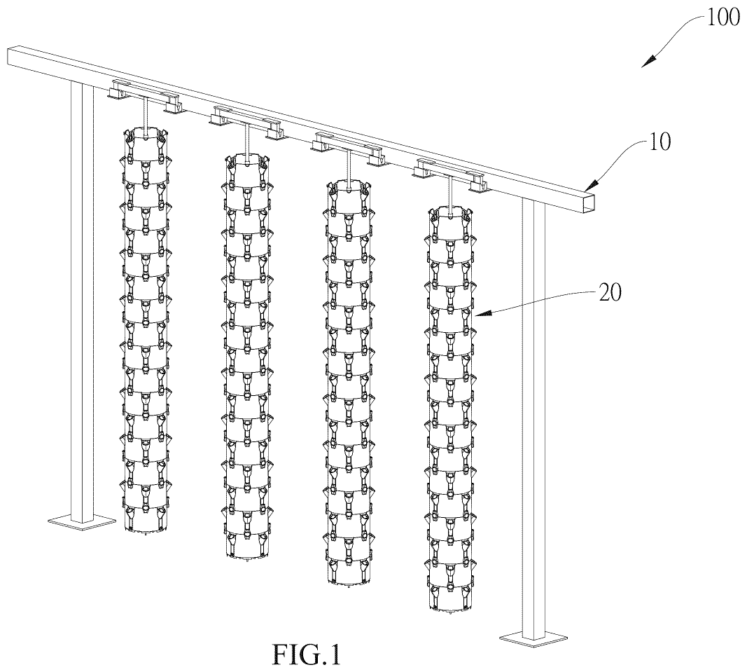

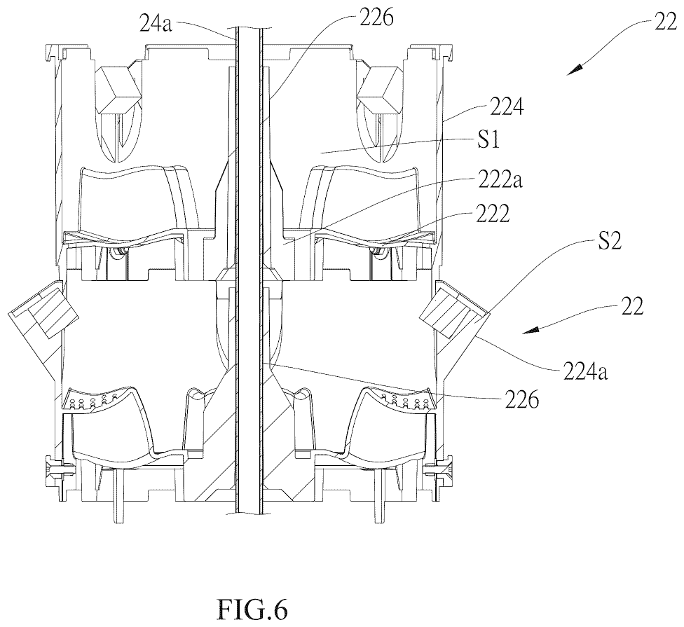

A vertical farming system 100 according to an embodiment of the present invention is illustrated in FIG. 1 to FIG. 7 and includes a support unit 10, at least one planting assembly 20, and a water circulation assembly 30. The support unit 10, the at least one planting assembly 20, and the water circulation assembly 30 are located in a cultivation room. The support unit 10 is adapted to support the at least one planting assembly 20. The water circulation assembly 30 is adapted to irrigate the at least one planting assembly 20.

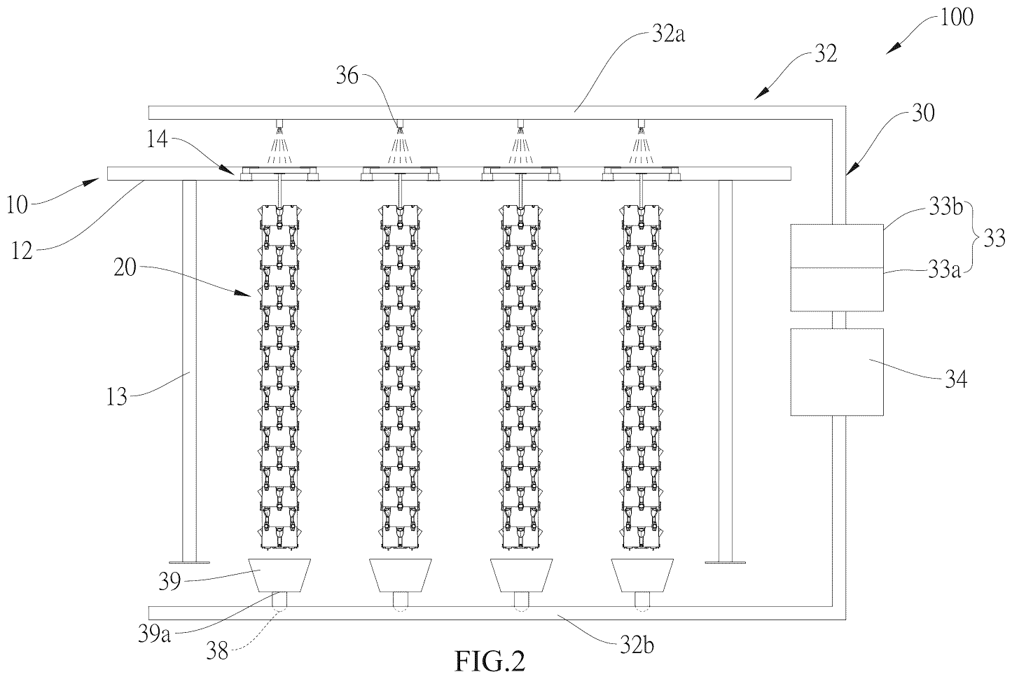

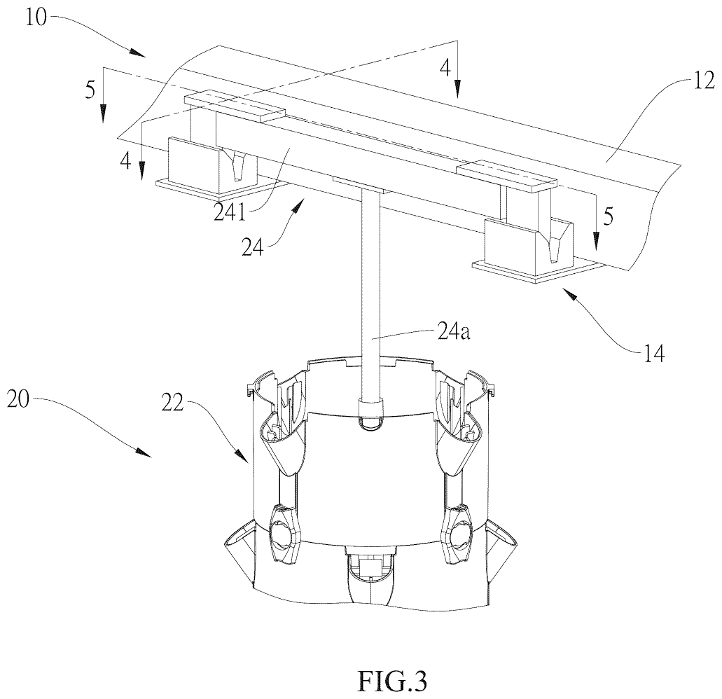

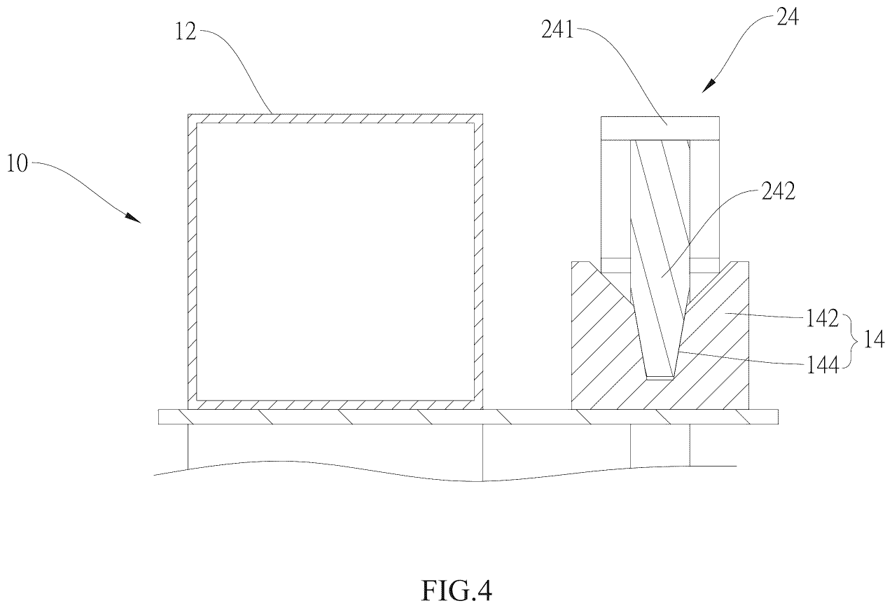

The support unit 10 includes a fixing rack 12. In the current embodiment, the fixing rack 12 are transversely raised through a plurality of support legs 13. However, the way to raise the fixing rack 12 is not limited to using the support legs 13; for example, two ends of the fixing rack 12 could be directly fixed to walls of a building. At least one positioning portion 14 is provided on the fixing rack 12 and is adapted to be correspondingly engaged with the at least one planting assembly 20. In the current embodiment, the positioning portion 14 is constituted by two support seats 142. As shown in FIG. 2 and FIG. 3, the two support seats 142 are fixed to an outer side of the fixing rack 12 and are spaced by an interval. Each of the support seats 142 has a slot 144 with an opening facing upward. Referring to FIG. 4, in the current embodiment, the slot 144 is a V-shaped groove.

As shown in FIG. 3 and FIG. 4, the at least one planting assembly 20 includes at least one plant container 22 and a hanging member 24, wherein the at least one plant container 22 is hung below the fixing rack 12 through the hanging member 24.

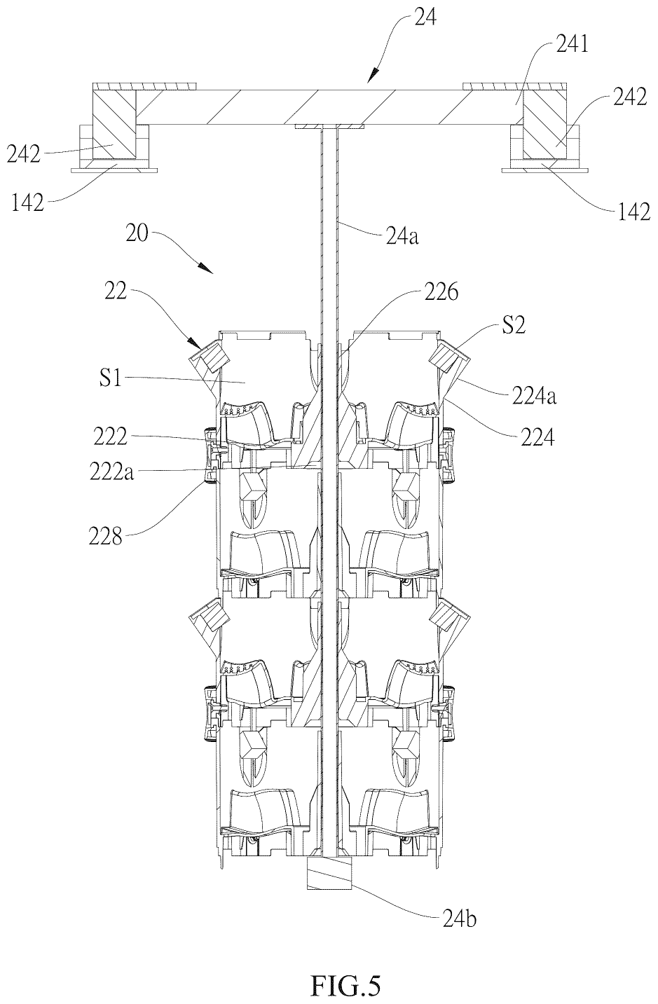

As shown in FIG. 3 and FIG. 5, the at least one plant container 22 of the at least one planting assembly 20 includes a bottom wall 222 and a sidewall 224 disposed along a peripheral edge of the bottom wall 222. The bottom wall 222 and the sidewall 224 jointly surround to form a receiving space S1 with an opening facing upward. The bottom wall 222 has a drainage hole 222a communicating the receiving space S1. The sidewall 224 has at least one protruding portion 224a protruding radially outward. The at least one protruding portion 224a has an expanded space S2 communicating with the receiving space S1 and an external of the plant container 22. The expanded space S2 of the protruding portion 224a receives a part of irrigation water. Upon irrigating the at least one plant container 22, the part of the irrigation water received by the expanded space S2 of the protruding portion 224a is absorbed by plants, while an excessive part of the irrigation water flows from the protruding portion 224a to the bottom wall 222 along an inner side of the sidewall 224 and is drained to a bottom through the drainage hole 222a.

In the current embodiment, the number of the plant container 22 of the planting assembly 20 is plural as an example for illustration. The plant containers 22 could be detachably stacked on one another. The bottom wall 222 of each of the plant containers 22 has a hollow tube 226, wherein the hollow tube 226 is located on an axis of the plant container 22, and the drainage hole 222a is located on a peripheral edge of the hollow tube 226. Moreover, referring to FIG. 5, in order to enhance the stacking stability of the plant containers 22, at least one buckle 228 is disposed between any two of the plant containers 22, which are vertically adjacent, and is adapted to connect the two plant containers 22. In the current embodiment, the number of the buckle 228 is four as an example for illustration, and each of the buckles 228 are located on an outer side of the sidewall 224 of the two plant containers 22. In other embodiments, the number of the buckle 228 could be one or plural, as long as the buckle 228 could connect the two plant containers 22, which are vertically stacked, and enhance the stacking stability of the plant containers 22.

The hanging member 24 of the at least one planting assembly 20 has a head, which is a rod body 241 as an example. Two ends of the rod body 241 are respectively disposed in the two slots 144 of the two support seats 142. In the current embodiment, the two ends of the rod body 241 respectively have an engaging block 242 protruding downward, wherein each of the engaging blocks 242 corresponds to each of the slots 144. When the hanging member 24 is disposed on the at least one positioning portion 14 of the fixing rack 12, the two engaging blocks 242 of the rod body 241 are inserted into the two slots 144 of the two support seats 142 from top down. The hanging member 24 further includes a connecting member 24a and a stop block 24b. A top end of the connecting member 24a is engaged with the rod body 241 of the hanging member 24. The connecting member 24a passes through the hollow tubes 226 of the stacked plant containers 22. The stop block 24b is disposed on a bottom end of the connecting member 24a and is in contact with the bottom wall 222 of one of the plant containers 22 that is bottommost, so that the plant containers 22 could not be detached relative to the connecting member 24a. In other embodiments, the number of the plant container 22 could be one or plural, depending on the requirement in growing plants and a raised height of the fixing rack 12 relative to a floor; the connecting member 24a could be, for example, a rigid rod or a steel cable.

Referring to FIG. 1 and FIG. 2, in the current embodiment, both the number of the positioning portion 14 and the number of the planting assembly 20 on the fixing rack 12 are plural, so that a mass planting could be performed in the cultivation room.

As shown in FIG. 2, the water circulation assembly 30 has a pipeline 32 and a nutrient device 33. The pipeline 32 has at least one outlet hole 36 and at least one collection hole 38. The nutrient device 33 is disposed on a water pathway of the pipeline 32 and is located between the at least one outlet hole 36 and the at least one collection hole 38. The nutrient device 33 is adapted to regulate a composition of the irrigation water. The irrigation water passes through the at least one outlet hole 36 to irrigate the plants in the plant containers 22 and passes through the drainage hole 222a of the plant containers 22 to return to the pipeline 32 via the at least one collection hole 38.

Moreover, in the current embodiment, the pipeline 32 is divided by the nutrient device 33 into an irrigation pipeline 32a and a collection pipeline 32b. The irrigation pipeline 32a is disposed above the plant container 22 of the at least one planting assembly 20 and has the at least one outlet hole 36. The collection pipeline 32b is disposed below the plant container 22 of the at least one planting assembly 20 and has the at least one collection hole 38. The water circulation assembly 30 includes at least one collection portion 39, wherein the at least one collection portion 39 is connected to the collection pipeline 32b and has a communicating hole 39a communicating with the collection hole 38. When the excessive part of the irrigation water is drained to the bottom through the drainage hole 222a of the plant containers 22 of the at least one planting assembly 20, the at least one collection portion 39 collects the excessive part of the irrigation water and the excessive part of the irrigation water passes through the communicating hole 39a and the at least one collection hole 38 to enter the collection pipeline 32b. After the nutrient device 33 regulates the composition of the irrigation water, the irrigation water is reused to irrigate the plant containers 22 of the at least one planting assembly 20 through the at least one outlet hole 36 of the irrigation pipeline 32a. In other embodiments, the irrigation pipeline 32a could be changed to be disposed below the plant containers 22 of the at least one planting assembly 20, as long as the at least one outlet hole 36 could allow the irrigation water to come out and irrigate the plants in the plant containers 22; alternatively, the at least one collection portion 39 and the communicating hole 39a could be omitted, as long as the at least one collection hole 38 could collect the irrigation water.

As shown in FIG. 2, the nutrient device 33 includes a water quality sensor 33a and a nutrient regulator 33b. The water quality sensor 33a is electrically connected to the nutrient regulator 33b and is adapted to detect the composition of the irrigation water in the pipeline 32, wherein a detection range of the water quality sensor 33a includes concentrations of nitrogen, phosphorus, potassium, or other nutrients required for plant growth, but not limited thereto. The water quality sensor 33a controls the nutrient regulator 33b to release one type of nutrient solutions or multiple types of nutrient solutions into the pipeline 32, so that the composition of the nutrients in the irrigation water could be adjusted, thereby reaching the composition that is the most suitable for plant growth. For example, when the water quality sensor 33a detects that the concentration of potassium in the irrigation water is lower than a concentration of potassium that is the most suitable for plant growth, the water quality sensor 33a sends a signal to the nutrient regulator 33b for controlling the nutrient regulator 33b to release a potassium solution into the pipeline 32, so that the concentration of potassium in the irrigation water is increased, thereby reaching the concentration of potassium that is the most suitable for plant growth.

In the current embodiment, the water circulation assembly 30 further includes a filter 34 disposed on the water pathway of the pipeline 32 and is located between the at least one outlet hole 36 and the at least one collection hole 38. The filter 34 is disposed between the nutrient device 33 and the collection hole 38. The filter 34 is adapted to filter solid granules in the irrigation water, thereby preventing a blockage of the pipeline 32 due to the solid granules and ensuring a smooth flow of the irrigation water in the water circulation assembly 30. In other embodiments, the filter 34 could be omitted, as long as the flow of the irrigation water in the water circulation assembly 30 is not interrupted.

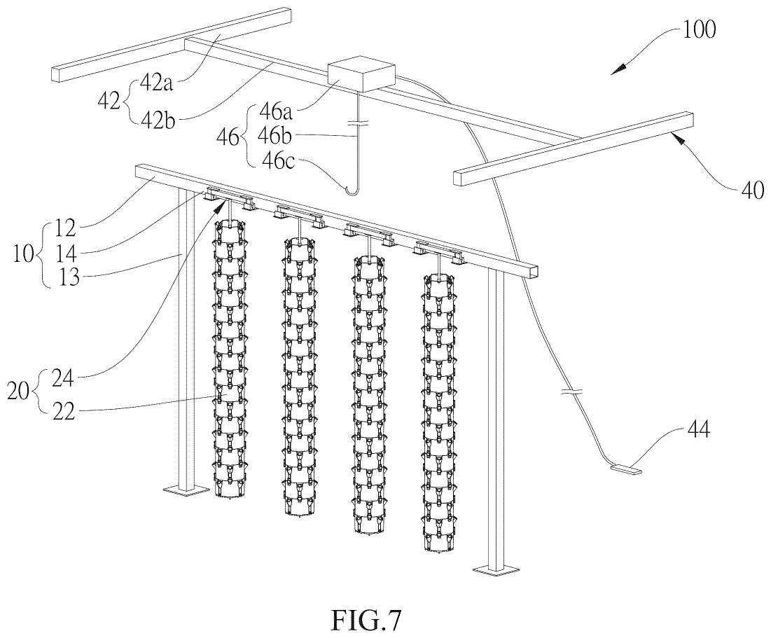

In addition, the vertical farming system 100 could further include a transporting device 40. As shown in FIG. 7, the transporting device 40 is adapted to remove the at least one planting assembly 20 from the at least one positioning portion 14 of the fixing rack 12 or place the at least one planting assembly 20 on the at least one positioning portion 14 of the fixing rack 12. The transporting device 40 includes a track 42, a controller 44, and a hanging mechanism 46. In the current embodiment, the track 42 is disposed in a top of the cultivation room and includes two guiding rails 42a and a beam 42b. The two guiding rails 42a are disposed parallelly. The beam 42b is connected between the two guiding rails 42a and is controlled by the controller 44 to move along a pathway provided by the two guiding rails 42a. The hanging mechanism 46 is installed on the beam 42b. The hanging mechanism 46 includes an electric motor 46a, a movable member 46b, and a hook 46c. The electric motor 46a is installed on the beam 42b and is controlled by the controller 44 to move along the beam 42b. The movable member 46b is a steel cable, wherein a part of the movable member 46b is wound on a reel (not shown) of the electric motor 46a. The controller 44 could control the reel to release a length of the movable member 46b. The hook 46c is connected to an end of the movable member 46b. The hook 46c could hook the head of the hanging member 24 and is controlled to lift or descend. When the at least one planting assembly 20 is required to be transported to other places, a user firstly controls, by using the controller 44, the beam 42b to move along the pathway of the two guiding rails 42a to a top of the fixing rack 12 and then controls the reel of the electric motor 46a to move along the beam 42b to a top of the at least one planting assembly 20; afterwards, the user controls the reel to release the length of the movable member 46b with the controller 44, so that the hook 46c descends and hooks the head of the hanging member 24. When the reel winds the movable member 46b to lift the hook 46c, the engaging blocks 242 of the rod body 241 is moved relative to the slots 144 of the two support seats 142, so that the head is disengaged with the positioning portion 14. Then the user controls the electric motor 46a and the beam 42b to move by using the controller 44, so that the at least one planting assembly 20 is moved to other places for harvesting conveniently.

In the current embodiment, the vertical farming system 100 removes the head of the hanging member 24 from the positioning portion 14 of the fixing rack 12 or places the head of the hanging member 24 on the positioning portion 14 of the fixing rack 12 through the track 42 and the hanging mechanism 44 of the transporting device 40. In other embodiment, the transporting device 40 could be replaced with an autonomous vehicle or any transporting device that could remove the head of the hanging member 24 from the positioning portion 14 of the fixing rack 12 or place the head of the hanging member 24 on the positioning portion 14 of the fixing rack 12, so that the at least one planting assembly 20 is removed from or placed on the support unit 10.

With the aforementioned design, the water circulation assembly 30 could effectively circulate and reuse the irrigation water, thereby reducing the waste of water resource. The head of the hanging member 24 is engaged with the positioning portion 14 in a detachable manner relative to the positioning portion 14 of the fixing rack 12, so that the at least one planting assembly 20 could be transported by the transporting device 40 to different places for the user to harvest conveniently, thereby enhancing the harvesting efficiency. Moreover, in comparison with a conventional agricultural system that requires a large space for growing a large number of plants, when a plurality of plant containers 22 of the present invention is disposed, the plant containers 22 could be stacked on one another, so that the vertical farming system 100 of the present invention could reduce a space required to dispose the planting assemblies 20, thereby reducing the cost of land by growing a large number of plants in a limited space.

It must be pointed out that the embodiments described above are only some preferred embodiments of the present invention. All equivalent structures which employ the concepts disclosed in this specification and the appended claims should fall within the scope of the present invention.

What is claimed is:

1. A vertical farming system, comprising:
a support unit comprising a fixing rack that is raised relative to a floor, wherein at least one positioning portion is provided on the fixing rack;
at least one planting assembly comprising a hanging member and at least one plant container, wherein the at least one plant container is hung below the fixing rack through the hanging member; the at least one plant container has a drainage hole adapted to drain irrigation water; the hanging member has a head, wherein the head is detachably engaged with the at least one positioning portion of the fixing rack; and
a water circulation assembly comprising a pipeline and a nutrient device, wherein the pipeline has at least one outlet hole and at least one collection hole; the nutrient device is disposed on a water pathway of the pipeline and is located between the at least one outlet hole and the at least one collection hole; the nutrient device is adapted to regulate a composition of the irrigation water; the irrigation water passes through the at least one outlet hole to irrigate plants in the at least one plant container; when the irrigation water passes through the drainage hole of the at least one plant container, the irrigation water returns to the pipeline through the at least one collection hole.

2. The vertical farming system as claimed in claim 1, wherein the pipeline of the water circulation assembly is divided by the nutrient device into an irrigation pipeline and a collection pipeline; the irrigation pipeline is disposed above the at least one plant container of the at least one planting assembly and has the at least one outlet hole; the collection pipeline is disposed below the at least one plant container of the at least one planting assembly and has the at least one collection hole; the at least one plant container of the at least one planting assembly comprises a bottom wall and a sidewall disposed along a peripheral edge of the bottom wall; the bottom wall and the sidewall jointly surround to form a receiving space with an opening facing upward; the sidewall has at least one protruding portion protruding radially outward; the at least one protruding portion has an expanded space communicating with the receiving space and an external of the at least one plant container; the expanded space of the at least one protruding portion receives a part of the irrigation water; the bottom wall has the drainage hole communicating with the receiving space.

3. The vertical farming system as claimed in claim 2, wherein the at least one plant container of the at least one planting assembly comprises a plurality of plant containers; the plurality of plant containers are detachably stacked on one another; each of the plurality of plant containers has a hollow tube; any two of the plurality of plant containers that are vertically adjacent are connected to each other through at least one buckle; the hanging member has a connecting member and a stop block; the connecting member passes through the hollow tube of each of the plurality of plant containers; the stop block is disposed on a bottom end of the connecting member and is in contact with the bottom wall of one of the plurality of plant containers that is bottommost, so that the plurality of plant containers are not detachable relative to the connecting member; a top end of the connecting member is engaged with the head.

4. The vertical farming system as claimed in claim 2, wherein the water circulation assembly comprises at least one collection portion; the at least one collection portion is connected to the collection pipeline and has a communicating hole communicating with the at least one collection hole.

5. The vertical farming system as claimed in claim 1, wherein the nutrient device comprises a water quality sensor and a nutrient regulator; the water quality sensor is electrically connected to the nutrient regulator and is adapted to detect the composition of the irrigation water; the water quality sensor controls the nutrient regulator to regulate the composition of the irrigation water.

6. The vertical farming system as claimed in claim 1, wherein the water circulation assembly further comprises a filter disposed on the water pathway of the pipeline and located between the at least one outlet hole and the at least one collection hole; the filter is adapted to filter the irrigation water.

7. The vertical farming system as claimed in claim 1, wherein the at least one positioning portion of the fixing rack comprises two support seats; the two support seats are spaced from each other and respectively have a slot with an opening facing upward; the head of the hanging member comprises a rod body, wherein two ends of the rod body are respectively disposed in the two slots of the two support seats.

8. The vertical farming system as claimed in claim 2, wherein the at least one positioning portion of the fixing rack comprises two support seats; the two support seats are spaced from each other and respectively have a slot with an opening facing upward; the head of the hanging member comprises a rod body, wherein two ends of the rod body are respectively disposed in the two slots of the two support seats.

9. The vertical farming system as claimed in claim 3, wherein the at least one positioning portion of the fixing rack comprises two support seats; the two support seats are spaced from each other and respectively have a slot with an opening facing upward; the head of the hanging member comprises a rod body, wherein two ends of the rod body are respectively disposed in the two slots of the two support seats.

10. The vertical farming system as claimed in claim 4, wherein the at least one positioning portion of the fixing rack comprises two support seats; the two support seats are spaced from each other and respectively have a slot with an opening facing upward; the head of the hanging member comprises a rod body, wherein two ends of the rod body are respectively disposed in the two slots of the two support seats.

11. The vertical farming system as claimed in claim 5, wherein the at least one positioning portion of the fixing rack comprises two support seats; the two support seats are spaced from each other and respectively have a slot with an opening facing upward; the head of the hanging member comprises a rod body, wherein two ends of the rod body are respectively disposed in the two slots of the two support seats.

12. The vertical farming system as claimed in claim 6, wherein the at least one positioning portion of the fixing rack comprises two support seats; the two support seats are spaced from each other and respectively have a slot with an opening facing upward; the head of the hanging member comprises a rod body, wherein two ends of the rod body are respectively disposed in the two slots of the two support seats.

13. The vertical farming system as claimed in claim 7, further comprising a transporting device adapted to remove the head of the hanging member from the at least one positioning portion of the fixing rack or place the head of the hanging member on the at least one positioning portion of the fixing rack.

14. The vertical farming system as claimed in claim 8, further comprising a transporting device adapted to remove the head of the hanging member from the at least one positioning portion of the fixing rack or place the head of the hanging member on the at least one positioning portion of the fixing rack.

15. The vertical farming system as claimed in claim 9, further comprising a transporting device adapted to remove the head of the hanging member from the at least one positioning portion of the fixing rack or place the head of the hanging member on the at least one positioning portion of the fixing rack.

16. The vertical farming system as claimed in claim 10, further comprising a transporting device adapted to remove the head of the hanging member from the at least one positioning portion of the fixing rack or place the head of the hanging member on the at least one positioning portion of the fixing rack.

17. The vertical farming system as claimed in claim 11, further comprising a transporting device adapted to remove the head of the hanging member from the at least one positioning portion of the fixing rack or place the head of the hanging member on the at least one positioning portion of the fixing rack.

18. The vertical farming system as claimed in claim 12, further comprising a transporting device adapted to remove the head of the hanging member from the at least one positioning portion of the fixing rack or place the head of the hanging member on the at least one positioning portion of the fixing rack.

19. The vertical farming system as claimed in claim 13, wherein the transporting device comprises a track and a hanging mechanism; the track is disposed above the fixing rack; the hanging mechanism is movable along the track; the hanging mechanism comprises a hook, wherein the hook hooks the head and is controlled to lift or descend.

20. The vertical farming system as claimed in claim 14, wherein the transporting device comprises a track and a hanging mechanism; the track is disposed above the fixing rack; the hanging mechanism is movable along the track; the hanging mechanism comprises a hook, wherein the hook hooks the head and is controlled to lift or descend.

21. The vertical farming system as claimed in claim 15, wherein the transporting device comprises a track and a hanging mechanism; the track is disposed above the fixing rack; the hanging mechanism is movable along the track; the hanging mechanism comprises a hook, wherein the hook hooks the head and is controlled to lift or descend.

22. The vertical farming system as claimed in claim 16, wherein the transporting device comprises a track and a hanging mechanism; the track is disposed above the fixing rack; the hanging mechanism is movable along the track; the hanging mechanism comprises a hook, wherein the hook hooks the head and is controlled to lift or descend.

23. The vertical farming system as claimed in claim 17, wherein the transporting device comprises a track and a hanging mechanism; the track is disposed above the fixing rack; the hanging mechanism is movable along the track; the hanging mechanism comprises a hook, wherein the hook hooks the head and is controlled to lift or descend.

24. The vertical farming system as claimed in claim 18, wherein the transporting device comprises a track and a hanging mechanism; the track is disposed above the fixing rack; the hanging mechanism is movable along the track; the hanging mechanism comprises a hook, wherein the hook hooks the head and is controlled to lift or descend.
